(19) United States
(12) Patent Application Publication
(10) Pub. No.: US 2022/0207366 A1
(43) Pub. Date: Jun. 30, 2022

(54) Action-Actor Detection with Graph Neural Networks from Spatiotemporal Tracking Data

(71) Applicant: STATS LLC, Chicago, IL (US)

(72) Inventors: Daniel Edison Marley, Chesterton, IN (US); Youssef Nashed, Chicago, IL (US); Long Sha, Brisbane (AU)

(73) Assignee: STATS LLC, Chicago, IL (US)

(21) Appl. No.: 17/645,539

(22) Filed: Dec. 22, 2021

Related U.S. Application Data
(60) Provisional application No. 63/130,999, filed on Dec. 28, 2020.

(51) Int. Cl. G06N 3/08

(52) U.S. Cl. CPC G06N 3/08

(57) ABSTRACT

A computing system retrieves tracking data from a data store. The tracking data includes a plurality of frames of data for a plurality of events across a plurality of seasons. The computing system converts the tracking data into a plurality of graph-based representations. A graph neural network learns to generate an action prediction for each player in each frame of the tracking data. The computing system generates a trained graph neural network based on the learning. The computing system receives target tracking data for a target event. The target tracking data includes a plurality of target frames. The computing system converts the target tracking data to a plurality of target graph-based representations. Each graph-based representation corresponds to a target frame of the plurality of target frames. The computing system generates, via the trained graph neural network, an action prediction for each player in each target frame.

### CROSS-REFERENCE TO RELATED APPLICATIONS

This application claims priority to U.S. Provisional Application Ser. No. 63/130,999, filed Dec. 28, 2020, which is hereby incorporated by reference in its entirety.

### FIELD OF THE DISCLOSURE

The present disclosure generally relates to system and method for predicting actions and actors, based on, for example, tracking data.

### BACKGROUND

When human behavior and human-to-human interactions are described, they are typically described as a sequence of activities or actions performed by specific actions, implying that the natural semantics of human behavior may be captured by understanding a series of actor-action pairs. Conventional approaches in the area of human activity recognition has involved computer vision. Such approaches primarily focused on top-down methods, in which videos of actions are used to predict actions in the scene at a frame level. While this approach may be useful for video tagging, such techniques are limited to performing action recognition in the image space, while the actual activity occurs in real-world coordinates. Action recognition in the image space, however, also comes with additional challenges, such as background clutter, viewpoint change, and irregular camera motion. The identification of actors involved is significantly more difficult in these top-down approaches.

### SUMMARY

In some embodiments, a method is disclosed herein. A computing system retrieves tracking data from a data store. The tracking data includes a plurality of frames of data for a plurality of events across a plurality of seasons. The computing system converts the tracking data into a plurality of graph-based representations. A graph neural network learns to generate an action prediction for each player in each frame of the tracking data. The computing system generates a trained graph neural network based on the learning. The computing system receives target tracking data for a target event. The target tracking data includes a plurality of target frames. The computing system converts the target tracking data to a plurality of target graph-based representations. Each graph-based representation corresponds to a target frame of the plurality of target frames. The computing system generates, via the trained graph neural network, an action prediction for each player in each target frame.

In some embodiments, a system is disclosed herein. The system includes a processor and a memory. The memory has programming instructions stored thereon, which, when executed by the processor, causes the system to perform one or more operations. The one or more operations include retrieving tracking data from a data store. The tracking data includes a plurality of frames of data for a plurality of events across a plurality of seasons. The one or more operations further include converting the tracking data into a plurality of graph-based representations. The one or more operations further include learning, by a graph neural network, to generate an action prediction for each player in each frame of the tracking data. The one or more operations further include generating a trained graph neural network based on the learning. The one or more operations further include receiving target tracking data for a target event. The target tracking data includes a plurality of target frames. The one or more operations further include converting the target tracking data to a plurality of target graph-based representations. Each graph-based representation corresponds to a target frame of the plurality of target frames. The one or more operations further include generating, via the trained graph neural network, an action prediction for each player in each target frame.

In some embodiments, a non-transitory computer readable medium is disclosed herein. The non-transitory computer readable medium includes one or more sequences of instructions, which, when executed by one or more processors, causes a computing system to perform operations. The operations include retrieving, by the computing system, tracking data from a data store. The tracking data includes a plurality of frames of data for a plurality of events across a plurality of seasons. The operations further include converting, by the computing system, the tracking data into a plurality of graph-based representations. The operations further include learning, by a graph neural network, to generate an action prediction for each player in each frame of the tracking data. The operations further include generating, by the computing system, a trained graph neural network based on the learning. The operations further include receiving, by the computing system, target tracking data for a target event. The target tracking data includes a plurality of target frames. The operations further include converting, by the computing system, the target tracking data to a plurality of target graph-based representations. Each graph-based representation corresponds to a target frame of the plurality of target frames. The operations further include generating, by the computing system via the trained graph neural network, an action prediction for each player in each target frame.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 illustrates a graph-based representation of an event, according to example embodiments.

FIG. 3 is a block diagram illustrating graph neural network, according to example embodiments.

FIG. 4 is a block diagram illustrating exemplary architecture of spatial dynamic graph generation network, according to example embodiments.

FIG. 5 is a flow diagram illustrating a method of generating a prediction model, according to example embodiments.

FIG. 6 is a flow diagram illustrating a method of predicting player actions from tracking data, according to example embodiments.

FIGS. 7A-D illustrate exemplary graphical representations of actors and their associated action prediction, according to example embodiments.

FIG. 8A is a block diagram illustrating a computing system, according to example embodiments.

FIG. 8B is a block diagram illustrating a computing system, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

One or more techniques described herein generally relate to a system and method for predicting actor actions from multi-agent tracking data. For example, given tracking data from a sporting event (e.g., basketball game, soccer match, etc.), the one or more techniques described herein are able to recognize each actor on a playing surface and predict an action associated with each actor. In some embodiments, the one or more techniques described herein may use a heterogenous graph to represent spatiotemporal tracking data for group activity recognition. The heterogeneous structure provides an improvement over conventional approaches by both decoupling the spatial domain from the temporal domain, as well as simplifying the overall learning process for identifying interactions between entities.

Detecting, understanding, and analyzing actions (e.g. shot, pass, dribble, save, tackle, etc.) occurring in a sporting event are fundamental to an understanding of the game itself. Historically, these events and the actors/agents participating in those events (e.g. the player who is taking the shot) had to be labeled via manual, human annotation. With tracking data, systems are able to identify (i.e., detect) these events and their associated agents directly from the motions of the players and ball. Previous approaches relied on heuristics (i.e., rules- a series of if-then statements) or simplistic machine learning approaches. These conventional approaches (particularly the manual annotation approach) are limited to only being able identify the onset of an event (e.g., the frame in which the shot was released from the shooter's hand).

One or more approaches described herein improves upon conventional systems by casting the task of action recognition as a sequence labeling problem in which the system is trained to predict the action for each actor in each frame from multiagent tracking data. For example, the present system may leverage a heterogenous graph representation of the tracking data to predict actions of each actor on the playing surface. To generate the action predictions, the present system may utilize a graph neural network that includes a multi-head self-attention module that eliminates the need to rely on heuristics, while also increasing the system's capacity to understand complex activity.

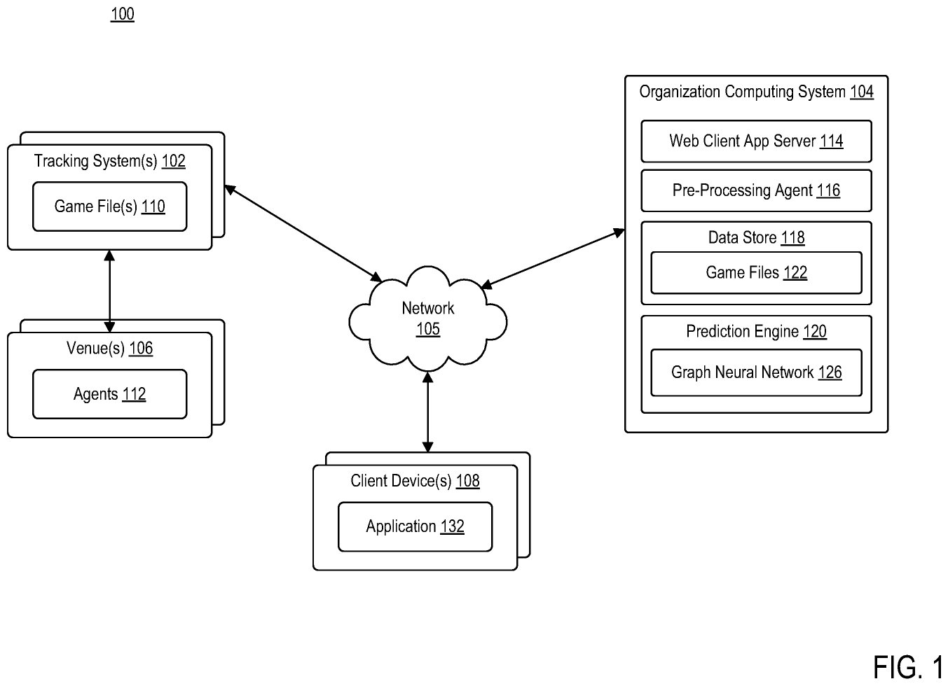

FIG. 1 is a block diagram illustrating a computing environment 100, according to example embodiments. Computing environment 100 may include tracking system 102, organization computing system 104, and one or more client devices 108 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™ ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Tracking system 102 may be positioned in a venue 106. For example, venue 106 may be configured to host a sporting event that includes one or more agents 112. Tracking system 102 may be configured to capture the motions of all agents (i.e., players) on the playing surface, as well as one or more other objects of relevance (e.g., ball, referees, etc.). In some embodiments, tracking system 102 may be an optically-based system using, for example, a plurality of fixed cameras. For example, a system of six stationary, calibrated cameras, which project the three-dimensional locations of players and the ball onto a two-dimensional overhead view of the court may be used. In another example, a mix of stationary and non-stationary cameras may be used to capture motions of all agents on the playing surface as well as one or more objects or relevance. As those skilled in the art recognize, utilization of such tracking system (e.g., tracking system 102) may result in many different camera views of the court (e.g., high sideline view, free-throw line view, huddle view, face-off view, end zone view, etc.). In some embodiments, tracking system 102 may be used for a broadcast feed of a given match. In such embodiments, each frame of the broadcast feed may be stored in a game file 110.

In some embodiments, game file 110 may further be augmented with other event information corresponding to event data, such as, but not limited to, game event information (pass, made shot, turnover, etc.) and context information (current score, time remaining, etc.).

Tracking system 102 may be configured to communicate with organization computing system 104 via network 105. Organization computing system 104 may be configured to manage and analyze the data captured by tracking system 102. Organization computing system 104 may include at least a web client application server 114, a pre-processing agent 116, a data store 118, and prediction engine 120. Each of pre-processing agent 116 and prediction engine 120 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

Data store 118 may be configured to store one or more game files 122. Each game file 122 may include data of a given match. For example, the data may correspond to a plurality of positional information for each agent captured by tracking system 102. In some embodiments, the data may correspond to broadcast data of a given match, in which case, the data may correspond to a plurality of positional information for each agent from the broadcast feed of a given match. Generally, such information may be referred to herein as “tracking data.” For example, tracking data may be extracted from video frames of the broadcast feed. Generally, tracking data may refer to the positions of the players/ball on the playing surface.

Pre-processing agent 116 may be configured to process data retrieved from data store 118. For example, pre-processing agent 116 may be configured to generate one or more sets of information that may be used with prediction engine 120. Pre-processing agent 116 may be further configured to generate a graph-based representation of tracking data for a given event. For example, for each game, pre-processing agent 116 may be configured to generate one or more graphs, with each graph corresponding to a respective game.

Generally, tracking data may include the x=(x, y) positions of each entity (or player) at each time step on a playing surface. In some embodiments, pre-processing agent 116 may construct a graph [symbol] ( [symbol] , ε) where each node vᵢ^{t} ∈ [symbol] may represent the coordinates of each entity i at time step t. The spatial positions xᵢ^{t} may be normalized based on the dimensions of the playing surface.

Due to the nature of spatiotemporal data, edges between nodes of the graph should exist in both spatial and temporal domains. However, defining a fully-connected graph not only makes the computation very expensive, but may also significantly increase the complexity of training because the entities' intersection in these two domains may have different properties. As a result, pre-processing agent 116 may define a heterogenous graph composed of different edge types assigned to temporal edges and spatial edges E={Eₛ, E_{τ}}.

Generally, in most group activities, the interactions between different entities may be dynamic, indicating edges between different entities could differ dramatically across time steps. To further simplify the problem, pre-processing agent 116 may define temporal edges to connect each entity to itself across frames. This may result in an adjacency matrix A_{t,t+1} between two consecutive frames. When two sequential frames have the same set of entities, A_{t,t+1} may be diagonal. There are three motivations for this temporal representation.

First, the motion features at each time step may only depend on its recent states, which allows such graph to be suitable for temporal feature extraction. Second, interactions between different entities at different time steps may also be acquired by iteratively passing messages through spatial and temporal edges. This may constrain the dynamic graph learning to remain in the spatial domain, which may simplify the training process. Finally, the computational overhead may be reduced compared to fully-connected graphs, where the cost would grow exponentially for longer sequences.

Because the temporal edges are fixed, the only dynamic piece remaining may be the spatial edges Eₛ, which may be expected to change across frames. Given the tracking data, pre-processing agent 116 may generate a partially defined graph representation [symbol] (V, Eₛ, Eₜ), where Eₛ may be unknown.

Prediction engine 120 may be configured to predict actions and actors in a group activity based on spatiotemporal data. For example, given tracking data from a frame, prediction engine 120 may include a model that is able to identify all actors and their corresponding actions. For example, as shown prediction engine 120 may include a graph neural network 126. Graph neural network 126 may be configured to identify both actions and actors in a group activity, such as a sporting event. Unlike other methods in action recognition domain that rely on appearance features, graph neural network 126 only relies on spatiotemporal data as input to make its predictions.

Generally, graph neural network 126 may be trained to learn the dynamic spatial relationships, Eₛ, and the weights θ of graph neural network simultaneously for node-level classification. For example, the node level-classification may be defined by:

$$Y = f ( 𝒢 ( 𝒱 , {ℰ}_{τ} ) ; {ℰ}_{s} , θ )$$

where Y may represent the set of action classification for all the nodes.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least application 132. Application 132 may be representative of a web browser that allows access to a website or a stand-alone application. Client device 108 may access application 132 to access one or more functionalities of organization computing system 104. Client device 108 may communicate over network 105 to request a webpage, for example, from web client application server 114 of organization computing system 104. For example, client device 108 may be configured to execute application 132 to access content managed by web client application server 114. The content that is displayed to client device 108 may be transmitted from web client application server 114 to client device 108, and subsequently processed by application 132 for display through a graphical user interface (GUI) of client device 108.

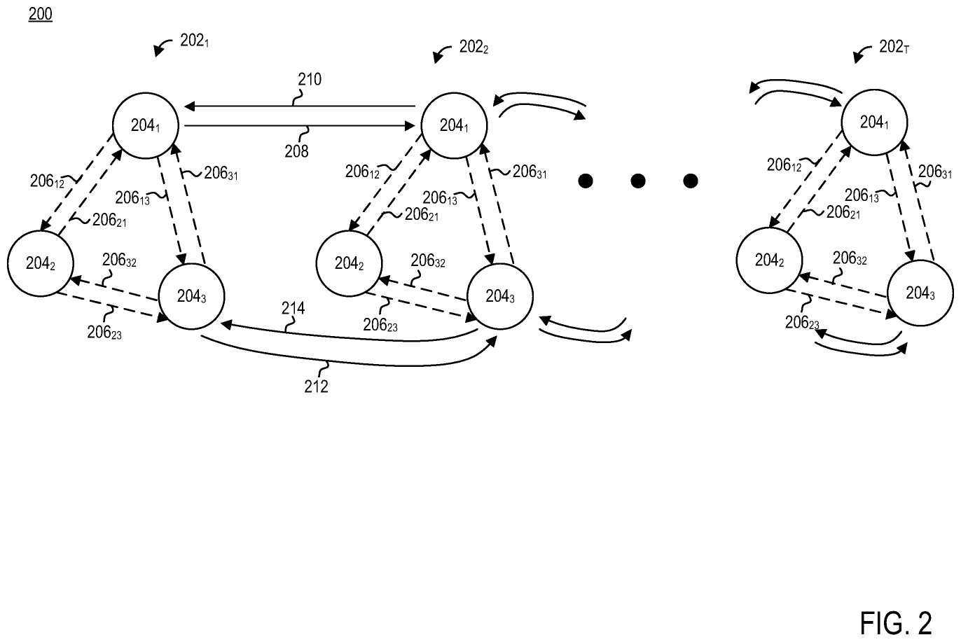

FIG. 2 illustrates a graph-based representation of an event, according to example embodiments. As provided above, for each event, pre-processing agent 116 may generate a graph-based representation of the agents involved in the event. For example, for each frame of a given event, pre-processing agent 116 may generate a graph-based representation of the agents and objects on the playing surface. The exemplary graph-based representation illustrated in FIG. 2 may represent a graph structure used to represent tracking data for a sequence with T time steps.

Graph 200 may include several time steps 202₁, 202₂, and 202_{T} (generally “time step 202”). Each time step 202 may include a plurality of nodes 204₁, 204₂, and 204₃, with each node representing an entity or player on the playing surface at a specific instance of time. As shown, nodes 204 may be connected both spatially and temporally via one or more edges.

Each spatial edge may denote a spatial relationship between various nodes on the playing surface. For example, time step 202₁ may include a first spatial edge 206₁₂ extending from node 204₁ to node 204₂; a second spatial edge 206₂₁ extending from node 204₂ to node 204₁; a third spatial edge 206₁₃ extending from node 204₁ to node 204₃; a fourth spatial edge 206₃₁ extending from node 204₃ to node 204₁; a fifth spatial edge 206₂₃ extending from node 204₂ to node 204₃; and a sixth spatial edge 206₃₂ extending from node 204₃ to node 204₂.

Each temporal edge may denote a temporal relationship between nodes representing the same entity across time steps 202₁-202_{T}. For example, a first temporal edge 208 may connect node 204₁ in time step 202₁ to node 204₁ in time step 202₂; a second temporal edge 210 may connect node 204₁ in time step 202₂ to node 204₁ in time step 202₁; a third temporal edge 212 may connect node 204₃ in time step 202₁ to node 204₃ in time step 202₂; and a fourth temporal edge 214 may connect node 204₃ in time step 202₂ to node 204₃ in time step 202₁.

The ellipses shown in FIG. 2 indicate that the graph may be connected for a variable number of time steps.

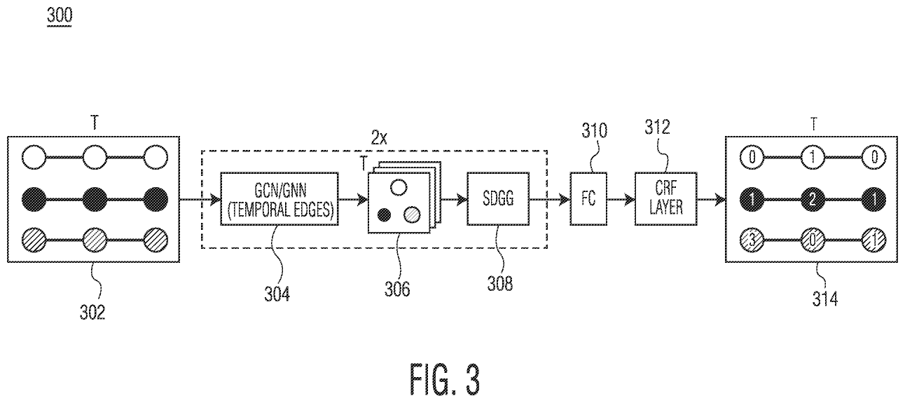

FIG. 3 is a block diagram illustrating graph neural network 300, according to example embodiments. In some embodiments, graph neural network 300 may be representative of an architecture corresponding to graph neural network 126 discussed above in conjunction with FIG. 1.

As shown, an input 302 may be provided to graph neural network 300. Input 302 may be a partially defined graph with fixed temporal edges that connect each entity to itself in consecutive frames, such as the example discussed above in conjunction with FIG. 2. Mathematically, input 302 may be represented as [symbol] ( [symbol] , E_{τ}). Input 302 may be fed into a graph convolutional network 304. Graph convolutional network 304 may be configured to extract the temporal features for each node and update the representation of each node. Mathematically, this may be represented as:

$${𝒱}^{′} = G C {N}_{τ} ( 𝒢 ( 𝒱 , {ℰ}_{τ} ) )$$

After the node representation may be updated with temporal features, the overall graph may be split into T sub-graphs 306, one per frame. Each sub-graph may be processed by spatial dynamic graph generation (SDGG) network 308. SDGG network 308 may be configured to generate dynamic graphs for each frame and may update the node representation with their spatial interactions.

As previously mentioned, graph neural network 300 may be configured to learn both the neural network weights and the spatial edges Eₛ^{t}. To simplify the learning, these tasks may be decoupled by using a self-attention mechanism to explicitly learn an adjacency matrix Aₜ at time t. Mathematically, this may be represented as:

$${𝒱}_{t}^{″} = {g}_{s} ( 𝒢 ( {𝒱}_{t}^{′} , s ( {𝒱}_{t}^{′} ) ) )$$

where s( ) may denote the self-attention network which outputs the adjacency matrix Aₜ, gₛ( ) may denote the GCN that operates on the spatial edges, and [symbol] ″ may denote the updated node representation at time t after spatial graph computation.

In some embodiments, the operations performed by graph convolutional network 304 and SDGG network 308 may be repeated more than once before generating a final classification. As shown, the output from SDGG network 308 may be provided to a fully connected (FC) layer 310 for classification. For example, FC layer 310 may classify each entity according to a predefined list of actions. In some embodiments, the predefined list of actions may be sports-specific. For example, the following actions may be possible actions for classification when the group activity is basketball: off-ball screen, closeout, hand-off, isolation, screen, post-up, drive, etc.

In operation, FC layer 310 may classify each entity as performing one of the actions in the list of actions. In some embodiments, the final output for each node may represent a probability distribution across all of the possible action classes. In some embodiments, the output from FC layer 310 (e.g., the action classification) may be provided to a conditional random field (CRF) layer 312. CRF layer 312 may be configured to smooth the final output sequence per entity. CRF layer 312 may be configured to generate output 314. As shown, output 314 may include each respective node as well as each node's action classification (e.g., action 0, action 1, action 2, etc.).

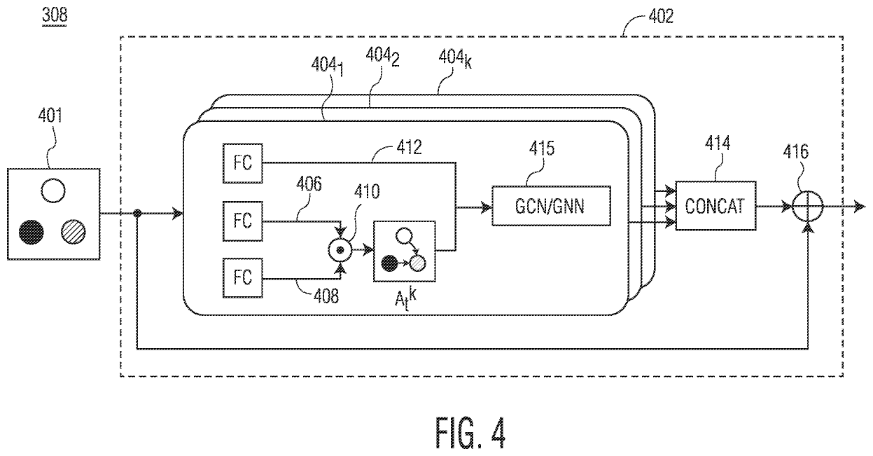

FIG. 4 is a block diagram illustrating exemplary architecture of SDGG network 308, according to example embodiments. In some embodiments, input 401 may be representative of the nodes from one frame of sub-graphs 306. Input 401 may be provided to SDGG network 308, as input, so that SDGG network 308 may generate the spatial relationships, Eₛ^{t}, at each time step t. In addition to having different Eₛ^{t} for each frame, due to the complex interaction in group activities, a multi-head self-attention module 402 may be used to generate a stack of graphs for each frame. For example, as shown, multi-head self-attention module 402 may include a plurality of heads 404₁, 404₂, 404ₖ (generally, head 404). Each head 404 may be configured to generate an adjacency matrix, Aₜ^{k}, for graph convolutional network. Intuitively, different actions may consist of interactions between different entities, thus having a stack of graphs may increase the capacity of graph neural network 300 for activity recognition.

In each head 404, two fully-connected streams 406 and 408 may be used to encode each node. In some embodiments, once each node is encoded, a dot product 410 may be applied to fully-connected stream 406 and fully connected stream 408, followed by a softmax activation function, to produce the attention coefficients of each node to other nodes, which may be considered as an adjacency matrix Aₜ^{k} for a particular graph k in frame t. In some embodiments, another fully-connected stream 412 may be used to project the node representation to the hidden space of this particular graph. Then both the adjacency matrix Aₜ^{k} and projected node representation may be fed into a GCN 415 to compute the new node representation. Node representations from all the graphs may then be concatenated (e.g., concat 414). In some embodiments, a residual connection 416 may be used at the end to prevent vanishing gradients by fusing the updated node representation and the input (e.g., each sub-graph 306).

To train network 300, a training data set that includes a plurality of events may be used. For example, a training set including a plurality of basketball games may be used to train graph neural network 300 to generate actions for each player on the playing surface. As those skilled in the art recognize, a plurality of games of soccer may be used to train graph neural network to generate actions for each player on the playing surface. The following discussion should not be limited to basketball or soccer and instead is meant to be exemplary and may be applied to all sports.

In each event or game, labeled tracking and event data may be used for model training. In some embodiments, the tracking data may be captured by tracking system 102 from broadcast video. The tracking data may include real-world positional coordinates (x, y) on the playing surface of each player that may be visible to the broadcast camera in each frame. In some embodiments, the event annotation may provide the coarse start frame of each event and the corresponding actors. In some embodiments, the data set may include a plurality of labeled actions, such as those provided above. For example, the plurality of labeled actions may include, but are not limited to, off-ball screen, closeout, hand-off, isolation, screen, post-up, and drive. In some embodiments, the training data set may include dilated event durations based on qualitative observations for possible start and end frames of the event relative to the labeled frame. Training may then be conducted on sequences of trajectory data. In some embodiments, each sequence may represent x seconds (e.g., 10 seconds) of continuous play.

During training, by applying CRF layer 312 on the predicted action sequence per entity, graph neural network 300 may be trained to produce a log-likelihood of the ground truth action sequence for that entity. Mathematically,

$$L L = - {\sum }_{i} log ( P ( {\overline{y}}_{i , 0} ) ) + {\sum }_{t = 1}^{T} ( log ( P ( {\overline{y}}_{i , t} ) ) + log ( P ( {\overline{y}}_{i , t} \vert {\overline{y}}_{i , t - 1} ) ) )$$

where y̅_{i,t} may represent the ground truth action of node i at time t, P(y̅_{i,t}) may represent emission probability of the action which is the output of FC layer 310, and P(y̅_{i,t}|y̅_{i,t-1}) may represent the transition probability from action y̅_{i,t-1} to y̅_{i,t}, which may be learned by CRF layer 312. In some embodiments, the training objective may maximize the likelihood of the ground truth action sequence.

Because this approach provides one likelihood per sequence, the likelihood may be severely biased towards “background” due to the class imbalance. To address this data imbalance issue, node-level classification loss may be included in the training process. For example, a class-balanced cross entropy loss may be used. Mathematically,

$${ℒ}_{c e} = {\sum }_{i} {\sum }_{t} α ( {\overline{y}}_{i , t} ) {\overline{y}}_{i , t} log ( {y}_{i} , t )$$

where α(y) may represent the per-sample weight for class y and y_{i,t} may represent the predicted action for entity i at time t.

The total loss that may be used for end-to-end training may be defined as:

$$ℒ = {ℒ}_{c e} + β \cdot LL$$

where β may be represtnative of the weighting factor for the log-likelihood.

In some embodiments, α(y) may be defined as:

$$α ( y ) = \{ \begin{matrix}\frac{10}{{N}_{y}} & if y = background \\ \frac{1}{{N}_{y}} & if otherwise\end{matrix}$$

where N_{y} may be representative of nodes that may be labeled as y. In some embodiments, the background class may be weighted more than non-background classes but may already be much lower than the actual background event distribution.

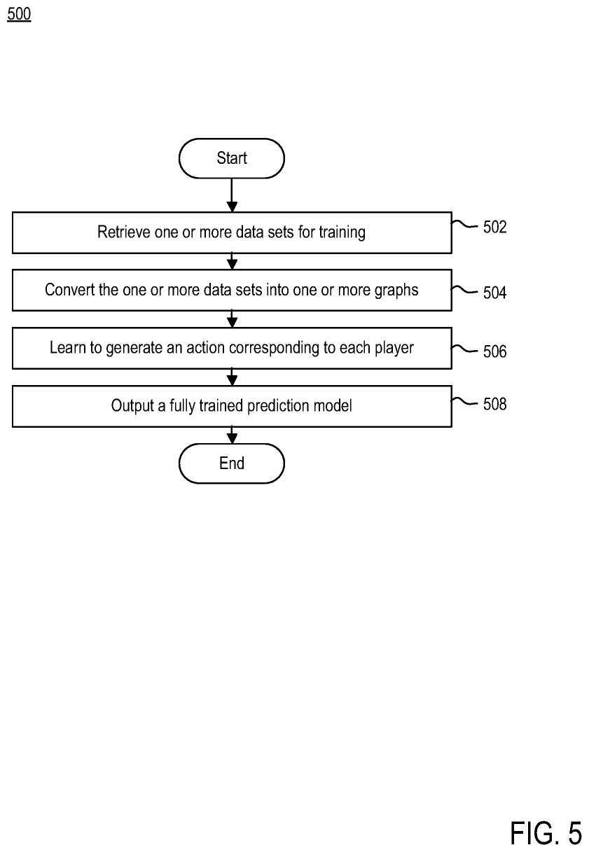

FIG. 5 is a flow diagram illustrating a method 500 of generating a prediction model, according to example embodiments. Method 500 may begin at step 502.

At step 502, organization computing system 104 may retrieve one or more data sets for training. For example, pre-processing agent 116 may retrieve one or more historical game files from data store 118. Each game file may include tracking data generated from broadcast video of the corresponding game. The tracking data may include real-world positional coordinates (x, y) on the playing surface of each player that may be visible to the broadcast camera in each frame. In some embodiments, the training data may further include event annotations that may provide the coarse start frame of each event and the corresponding actors. In some embodiments, the training data set may further include a plurality of labeled actions for each player in each frame.

At step 504, organization computing system 104 may convert the one or more data sets into one or more graphs. For example, pre-processing agent 116 may generate a graph-based representation of the broadcast video based on the tracking data. In some embodiments, for each game, pre-processing agent 116 may generate one or more graphs, with each graph corresponding to a respective game. Pre-processing agent 116 may construct a graph [symbol] ( [symbol] , E) where each node vᵢ^{t} ∈ [symbol] may represent the coordinates of each entity i at time step t. The spatial positions xᵢ^{t} may be normalized based on the dimensions of the playing surface. In some embodiments, pre-processing agent 116 may define a heterogenous graph composed of different edge types assigned to temporal edges and spatial edges E={Eₛ,E_{τ}}. Accordingly, given the tracking data, pre-processing agent 116 may generate a partially defined graph representation [symbol] (V, Eₛ, Eₜ).

At step 506, organization computing system 104 may learn, based on the one or more graphs, to generate an action corresponding to each player. For example, prediction engine 120 may learn, based on the one or more graphs, how to classify an action of each player on the playing surface at a particular moment of the game. In some embodiments, prediction engine 120 may train graph neural network 126 to identify an action of each individual on the playing surface based on a player's temporal position and spatial position.

At step 508, organization computing system 104 may output a fully trained prediction model. For example, at the end of the training and testing processes, prediction engine 120 may include a fully trained graph neural network 126.

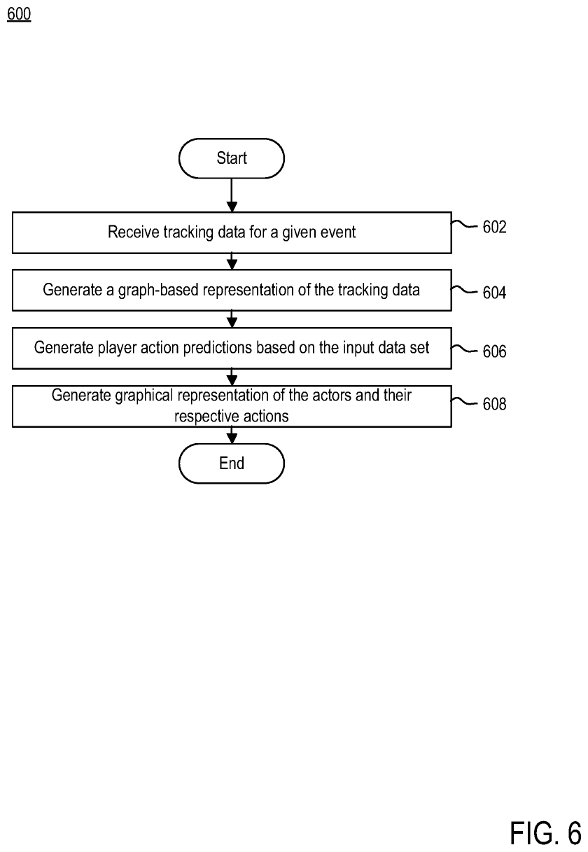

FIG. 6 is a flow diagram illustrating a method 600 of predicting player actions from tracking data, according to example embodiments. Method 600 may begin at step 602.

At step 602, organization computing system 104 may receive tracking data for a given event. For example, organization computing system 104 may receive one or more frames of video data captured by tracking system 102 in a given venue. In some embodiments, organization computing system 104 may receive tracking data from client device 108. For example, a user, via application 132, may request that an action-actor prediction be generated for a given frame or frames of video information.

At step 604, organization computing system 104 may generate a graph-based representation of the tracking data. For example, may generate a graph-based representation of the broadcast video based on the tracking data. In some embodiments, for each game, pre-processing agent 116 may generate one or more graphs, with each graph corresponding to a respective game. Pre-processing agent 116 may construct a graph [symbol] ( [symbol] , E) where each node vᵢ^{t} ∈ V may represent the coordinates of each entity i at time step t. The spatial positions xᵢ^{t}, may be normalized based on the dimensions of the playing surface. In some embodiments, pre-processing agent 116 may define a heterogenous graph composed of different edge types assigned to temporal edges and spatial edges E={Eₛ, E_{τ}}. Accordingly, given the tracking data, pre-processing agent 116 may generate a partially defined graph representation [symbol] (V, Eₛ, E_{τ}).

At step 606, organization computing system 104 may generate player action predictions based on the input data set. For example, prediction engine 120 may generate the player action prediction by inputting the graph-based representation into graph neural network 126. Graph neural network 126 may generate, as output, a player action prediction for all players visible in the input data set.

In some embodiments, method 600 may further include step 608. At step 608, organization computing system 104 may generate one or more graphical representations of the actors and their associated action prediction.

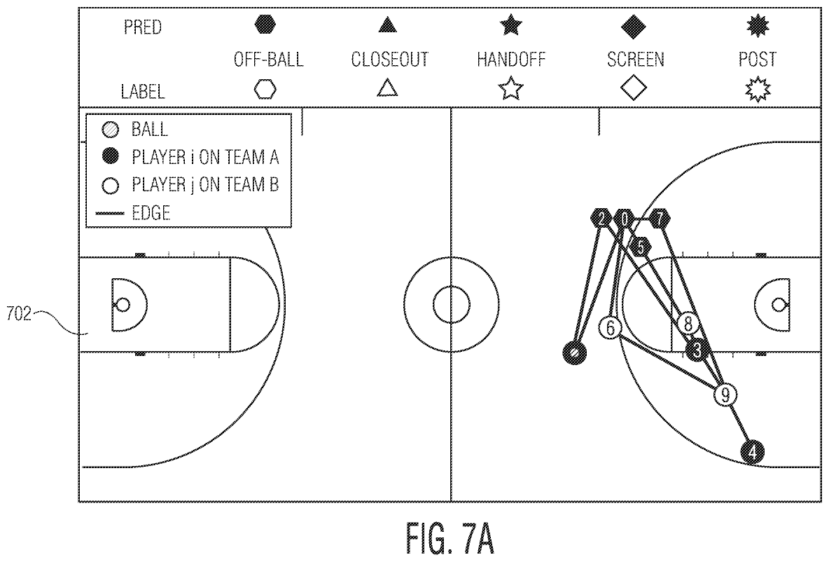

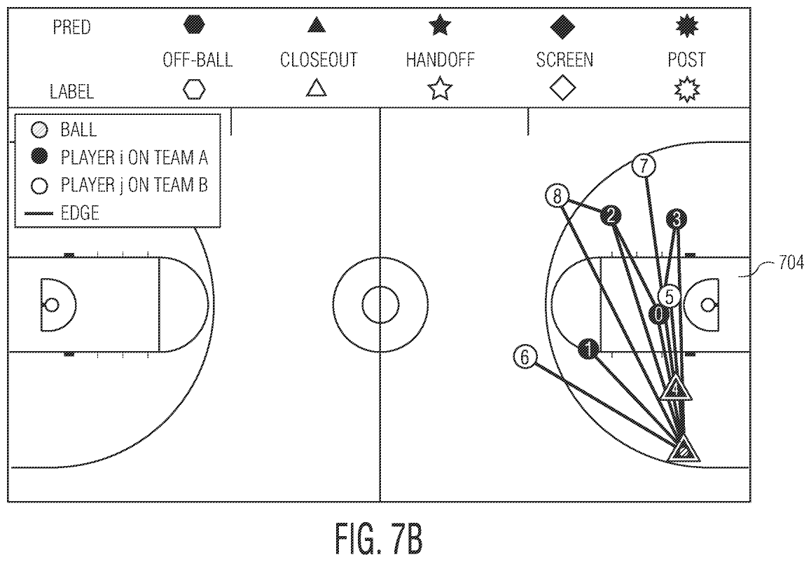

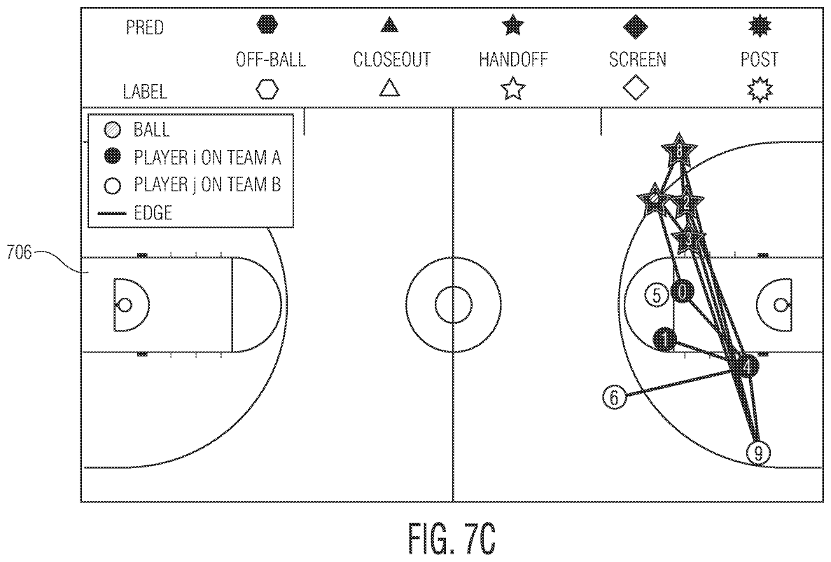

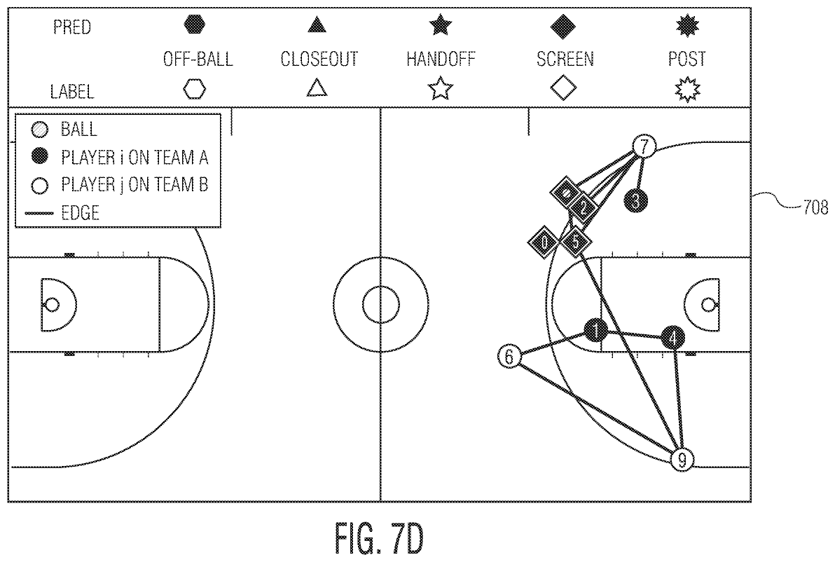

FIGS. 7A-7D illustrate exemplary graphical representations of actors and their associated action prediction, according to example embodiments. As shown, FIG. 7A includes graphical representation 702, FIG. 7B includes graphical representation 704, FIG. 7C includes graphical representation 706, and FIG. 7D includes graphical representation 708. Each graphical representation includes a representation of each player on the playing surface as well as their associated action, as predicted by graph neural network 126.

In some embodiments, in addition to the predicted and labeled events, each graphical representation may include connections between different entities on the playing surface. In some embodiments, these connections may be learned by graph neural network 126 and may indicate different relationships that may have been influential in the final activity recognition task. In some embodiments, graph neural network 126 may further indicate a connection between players and the ball. Graph neural network 126 may be configured to understand the ball's role in basketball and its influence on motions and activities.

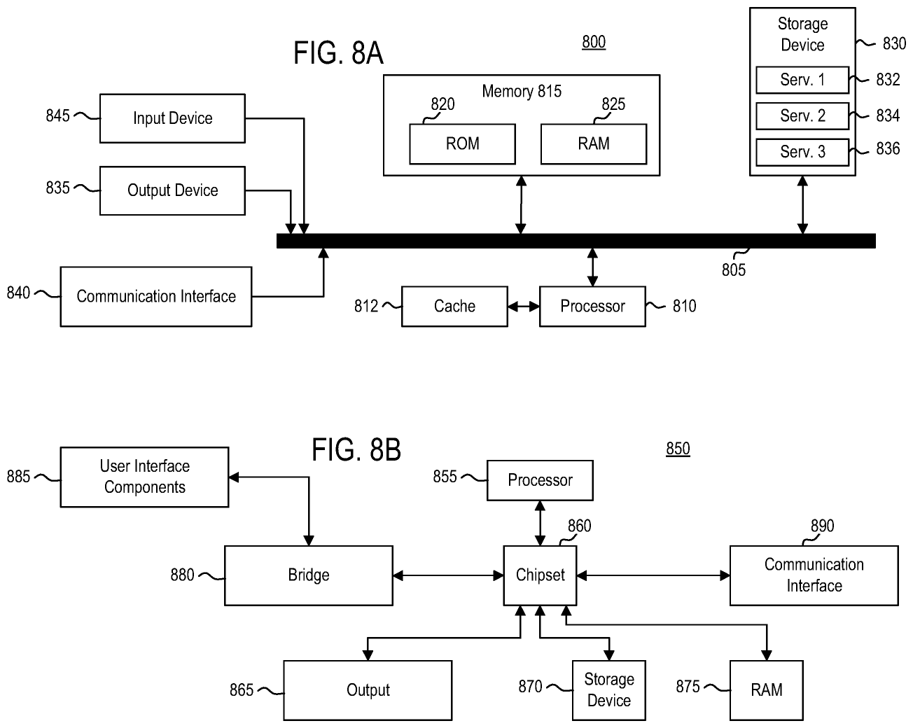

FIG. 8A illustrates a system bus architecture of computing system 800, according to example embodiments. System 800 may be representative of at least a portion of organization computing system 104. One or more components of system 800 may be in electrical communication with each other using a bus 805. System 800 may include a processing unit (CPU or processor) 810 and a system bus 805 that couples various system components including the system memory 815, such as read only memory (ROM) 820 and random access memory (RAM) 825, to processor 810. System 800 may include a cache of high-speed memory connected directly with, in close proximity to, or integrated as part of processor 810. System 800 may copy data from memory 815 and/or storage device 830 to cache 812 for quick access by processor 810. In this way, cache 812 may provide a performance boost that avoids processor 810 delays while waiting for data. These and other modules may control or be configured to control processor 810 to perform various actions. Other system memory 815 may be available for use as well. Memory 815 may include multiple different types of memory with different performance characteristics. Processor 810 may include any general purpose processor and a hardware module or software module, such as service 1 832, service 2 834, and service 3 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction with the computing system 800, an input device 845 may represent any number of input mechanisms, such as a microphone for speech, a touch-sensitive screen for gesture or graphical input, keyboard, mouse, motion input, speech and so forth. An output device 835 may also be one or more of a number of output mechanisms known to those of skill in the art. In some instances, multimodal systems may enable a user to provide multiple types of input to communicate with computing system 800. Communications interface 840 may generally govern and manage the user input and system output. There is no restriction on operating on any particular hardware arrangement and therefore the basic features here may easily be substituted for improved hardware or firmware arrangements as they are developed.

Storage device 830 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 825, read only memory (ROM) 820, and hybrids thereof

Storage device 830 may include services 832, 834, and 836 for controlling the processor 810. Other hardware or software modules are contemplated. Storage device 830 may be connected to system bus 805. In one aspect, a hardware module that performs a particular function may include the software component stored in a computer-readable medium in connection with the necessary hardware components, such as processor 810, bus 805, output device 835 (e.g., display), and so forth, to carry out the function.

FIG. 8B illustrates a computer system 850 having a chipset architecture that may represent at least a portion of organization computing system 104. Computer system 850 may be an example of computer hardware, software, and firmware that may be used to implement the disclosed technology. System 850 may include a processor 855, representative of any number of physically and/or logically distinct resources capable of executing software, firmware, and hardware configured to perform identified computations. Processor 855 may communicate with a chipset 860 that may control input to and output from processor 855. In this example, chipset 860 outputs information to output 865, such as a display, and may read and write information to storage device 870, which may include magnetic media, and solid state media, for example. Chipset 860 may also read data from and write data to storage device 875 (e.g., RAM). A bridge 880 for interfacing with a variety of user interface components 885 may be provided for interfacing with chipset 860. Such user interface components 885 may include a keyboard, a microphone, touch detection and processing circuitry, a pointing device, such as a mouse, and so on. In general, inputs to system 850 may come from any of a variety of sources, machine generated and/or human generated.

Chipset 860 may also interface with one or more communication interfaces 890 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 855 analyzing data stored in storage device 870 or storage device 875. Further, the machine may receive inputs from a user through user interface components 885 and execute appropriate functions, such as browsing functions by interpreting these inputs using processor 855.

It may be appreciated that example systems 800 and 850 may have more than one processor 810 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method, comprising:
retrieving, by a computing system, tracking data from a data store, the tracking data comprising a plurality of frames of data for a plurality of events across a plurality of seasons;
converting, by the computing system, the tracking data into a plurality of graph-based representations;
learning, by a graph neural network, to generate an action prediction for each player in each frame of the tracking data;
generating, by the computing system, a trained graph neural network based on the learning;
receiving, by the computing system, target tracking data for a target event, the target tracking data comprising a plurality of target frames;
converting, by the computing system, the target tracking data to a plurality of target graph-based representations, wherein each graph-based representation correspond to a target frame of the plurality of target frames; and
generating, by the computing system via the trained graph neural network, an action prediction for each player in each target frame.

2. The method of claim 1, wherein the graph neural network comprises a spatial dynamic graph generation network configured to update the graph-based representation with spatial interaction data among players.

3. The method of claim 2, wherein the spatial dynamic graph generation network comprises a multi-head self-attention module comprising a plurality of heads, wherein each head corresponds to a respective action of a plurality of actions for classification.

4. The method of claim 3, wherein each head of the plurality of heads is configured to generate an adjacency matrix.

5. The method of claim 2, where learning, by the graph neural network, to generate the action prediction for each player in each frame of the tracking data, comprises:
learning spatial relationships between each player in each frame of the tracking data; and
learning neural network weights.

6. The method of claim 2, wherein learning, by the graph neural network, to generate the action prediction for each player in each frame of the tracking data, comprises:
extracting temporal features from the tracking data.

7. The method of claim 1, wherein learning, by the graph neural network, to generate the action prediction for each player in each frame of the tracking data, comprises:
learning to generate a probability distribution across all possible action classes for each player in each frame.

8. A system, comprising:
a processor; and
a memory having programming instructions stored thereon, which, when executed by the processor, causes the system to perform one or more operations, comprising:
retrieving tracking data from a data store, the tracking data comprising a plurality of frames of data for a plurality of events across a plurality of seasons;
converting the tracking data into a plurality of graph-based representations;
learning, by a graph neural network, to generate an action prediction for each player in each frame of the tracking data;
generating a trained graph neural network based on the learning;
receiving target tracking data for a target event, the target tracking data comprising a plurality of target frames;
converting the target tracking data to a plurality of target graph-based representations, wherein each graph-based representation corresponds to a target frame of the plurality of target frames; and
generating, via the trained graph neural network, an action prediction for each player in each target frame.

9. The system of claim 8, wherein the graph neural network comprises a spatial dynamic graph generation network configured to update the graph-based representation with spatial interaction data among players.

10. The system of claim 9, wherein the spatial dynamic graph generation network comprises a multi-head self-attention module comprising a plurality of heads, wherein each head corresponds to a respective action of a plurality of actions for classification.

11. The system of claim 10, wherein each head of the plurality of heads is configured to generate an adjacency matrix.

12. The system of claim 9, where learning, by the graph neural network, to generate the action prediction for each player in each frame of the tracking data, comprises:
learning spatial relationships between each player in each frame of the tracking data; and
learning neural network weights.

13. The system of claim 9, wherein learning, by the graph neural network, to generate the action prediction for each player in each frame of the tracking data, comprises:
extracting temporal features from the tracking data.

14. The system of claim 8, wherein learning, by the graph neural network, to generate the action prediction for each player in each frame of the tracking data, comprises:
learning to generate a probability distribution across all possible action classes for each player in each frame.

15. A non-transitory computer readable medium comprising one or more sequences of instructions, which, when executed by one or more processors, causes a computing system to perform operations, comprising:
retrieving, by the computing system, tracking data from a data store, the tracking data comprising a plurality of frames of data for a plurality of events across a plurality of seasons;
converting, by the computing system, the tracking data into a plurality of graph-based representations;
learning, by a graph neural network, to generate an action prediction for each player in each frame of the tracking data;
generating, by the computing system, a trained graph neural network based on the learning;
receiving, by the computing system, target tracking data for a target event, the target tracking data comprising a plurality of target frames;
converting, by the computing system, the target tracking data to a plurality of target graph-based representations, wherein each graph-based representation corresponds to a target frame of the plurality of target frames; and
generating, by the computing system via the trained graph neural network, an action prediction for each player in each target frame.

16. The non-transitory computer readable medium of claim 15, wherein the graph neural network comprises a spatial dynamic graph generation network configured to update the graph-graph based representation with spatial interaction data among players.

17. The non-transitory computer readable medium of claim 16, wherein the spatial dynamic graph generation network comprises a multi-head self-attention module comprising a plurality of heads, wherein each head corresponds to a respective action of a plurality of actions for classification.

18. The non-transitory computer readable medium of claim 16, where learning, by the graph neural network, to generate the action prediction for each player in each frame of the tracking data, comprises:
learning to spatial relationships between each player in each frame of the tracking data; and
learning neural network weights.

19. The non-transitory computer readable medium of claim 16, wherein learning, by the graph neural network, to generate the action prediction for each player in each frame of the tracking data, comprises:
extracting temporal features from the tracking data.

20. The non-transitory computer readable medium of claim 15, wherein learning, by the graph neural network, to generate the action prediction for each player in each frame of the tracking data, comprises:
learning to generate a probability distribution across all possible action classes for each player in each frame.
